(19) United States
(12) Patent Application Publication
(10) Pub. No.: US 2008/0272573 A1
(43) Pub. Date: Nov. 6, 2008

(54) Cushion support for wheelchairs

(76) Inventor: Herschel Hiatt, El Paso, TX (US)

Correspondence Address: The Halvorson Law Firm;Ste 130, 1757 E. Baseline Rd., Gilbert, AZ, 85233, US

(21) Appl. No.: 11/800,312

(22) Filed: May 4, 2007

(51) Int. Cl. A61G 5/12

(52) U.S. Cl. 280/304.1

(57) ABSTRACT

An apparatus for securing a cushion to the lower leg cradles of a wheelchair. The apparatus includes a rectangular back section that rests against the leg cradles, and is easily secured to a wheelchair by mounting straps and footrest straps. Adjustable holding straps are positioned along the edges of the apparatus to secure a leg cushion of variable size between a passenger's calves and the back section. The apparatus can also be stored on back steering handles of a wheelchair by using the footrest straps as hangers.

### BACKGROUND OF THE INVENTION

1. Technical Field of the Invention:

This invention relates to attachments for wheelchairs, particularly those attachments that provide added comfort for wheelchair passengers.

2. Description of the Related Art:

Wheelchairs are the most common means of manual transportation for individuals suffering with a variety of temporary or permanent disabilities. Most wheelchairs in use today, however, provide only minimal support and comfort options for passengers.

Because of the minimal support and cushioning of most common wheelchairs, passengers will often attempt to improvise the cushioning and comfort of a wheelchair by placing a pillow or other comfort item across the back or sides of the wheelchair sitting area. The metal leg cradles of most wheelchairs, however, are generally not conducive to adding cushioning for the calves and feet since any added cushioning typically falls between the metal leg cradles.

Other inventions have addressed the problem of providing comfort to the calves and feet of wheelchair passengers. For example, see the disclosures of U.S. Pat. Nos. 2,609,864; 2,735,480; and 6,168,238 B1. The '864 and '480 references provide added comfort by allowing a passenger to adjust the resting height of the lower legs. The '238 patent provides added passenger comfort through the use of a detachable and inflatable support member with air channels to cushion the calves of a wheelchair passenger.

The present invention provides a means to attach a cushion to the leg area of a common wheelchair. Unlike the '238 patent, however, the present invention provides a means to secure a cushion of the passenger's choosing to the leg cradles of a wheelchair, in any position desired by the passenger, in order to improve the comfort of a passenger's lower legs. Further, the present invention is easily removed and stowed on the back of the wheelchair when not in use.

### BRIEF SUMMARY OF THE INVENTION

It is an object of the present invention to provide a device that includes a rectangular pouch that is attachable to leg cradles and footrests of a common wheelchair by at least one, but preferably two adjustable mounting straps and at least one, but preferably two footrest straps. The pouch is made of a flexible material such as cloth, vinyl, or other flexible and cleanable material. The two adjustable mounting straps are located along first and second side lower edges of the pouch. The two adjustable mounting straps are preferably secured to the first and second wheelchair leg cradles with hook and loop fasteners, snaps, buttons or other like reusable fasteners commonly found in the industry.

It is another object of the present invention to provide the two footrest straps attached to a lower edge of the pouch and extending from opposite ends of the lower edge, respectively. The footrest straps are preferably loops of a flexible and cleanable material, however other configurations of straps may be used and still fall within the scope of the present invention. The footrest straps are of fixed and sufficient length to fit around a wheelchair's metal footrests. The footrest straps can also be used to hang the pouch over back steering handles of the wheelchair for ease of stowage and access.

It is yet another object of the present invention to provide a solid rectangular sheet of semi-rigid material that is sized to fit inside the pouch. The solid rectangular sheet is inserted through a top edge of the pouch, and provides stability and rigidity for the pouch as it rests against a wheelchair's metal leg cradles.

It is still yet another object of the present invention to provide holding straps that are positioned to secure a cushion of a passenger's choosing to a front surface of the pouch. A first embodiment of the holding straps includes three holding straps with hook and loop fasteners on both ends. The three holding straps are of sufficient length to attach at any first point along a periphery edge of the pouch, extend over the top of a cushion, and reattach at a second point along a periphery edge of the pouch that is opposite the first point.

A second embodiment of the holding straps includes six holding straps at adjustable positions along the periphery of the pouch. The second embodiment includes two upper holding straps that are secured to the top edge of the pouch near first and second upper corners. The two upper holding straps are of sufficient length to extend from the top to the bottom of the pouch while traversing the top side of a cushion. The upper holding straps are secured to the lower edge of the pouch with hook and loop fasteners, snaps, buttons or the like.

The second embodiment of the holding straps also includes two side holding straps that are secured to a first side edge of the pouch. The side holding straps are of sufficient length to extend from the first to the second side edges of the pouch while traversing the top side of a cushion. The side holding straps are secured to the second side edge of the pouch with hook and loop fasteners, snaps, buttons or the like.

The second embodiment of the holding straps further includes two corner holding straps that are secured to the upper and lower first side corners of the pouch. The corner holding straps are of sufficient length to extend from the upper first side to the lower second side corner of the pouch, and the lower first side to the upper second side corner of the pouch respectively. The corner holding straps are secured to the upper and lower second side corners of the pouch with hook and loop fasteners, snaps, buttons or the like.

When secured to the leg posts and footrests of a wheelchair, the present invention will hold a cushion in place between a passenger's calves and the leg cradles of a wheelchair.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means or step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE SEVERAL VIEWS OF THE DRAWINGS

FIG. 1 depicts a wheelchair with passenger in a standard configuration of frame, wheels, seating area, steering handles, leg supports and footrests, and further shows the proper positioning of the present invention behind the passenger's legs.

FIG. 2 depicts the wheelchair of FIG. 1 without passenger, and provides a front view of the present invention in its proper secured position covering the leg cradles of the wheelchair.

FIG. 3 depicts the wheelchair of FIG. 2 with a cushion properly secured by the present invention.

FIG. 4 depicts the front view of the present invention showing the pouch, two adjustable mounting straps, two footrest straps, six holding straps, and the approximate location of stitching or other closure means along the footrest straps and three periphery edges of the pouch.

FIG. 5 depicts the back view of the present invention showing the pouch, two adjustable mounting straps, two footrest straps, six holding straps, and the approximate location of stitching or other closure means along the footrest straps and three periphery edges of the pouch.

FIG. 6 depicts the full assembly of the present invention including all components of FIG. 4 plus a directional arrow to indicate the insertion of a solid rectangular sheet into the pouch to provide the proper stability.

FIG. 7 depicts the positioning and placement of the present invention onto a wheelchair's steering handles for ease of stowage and access.

FIG. 7a depicts the present invention hanging from a wheelchair's steering handles by the footrest loops.

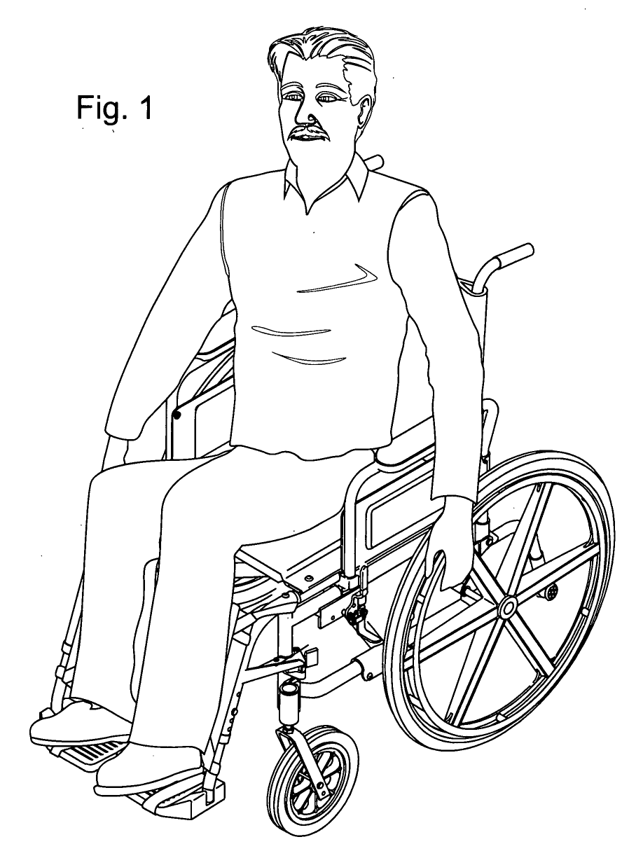

### DESCRIPTION OF PREFERRED EMBODIMENTS

When secured to the leg posts and footrests of a wheelchair 1, the present invention will hold a cushion in place between a passenger's calves and the leg cradles of a wheelchair.

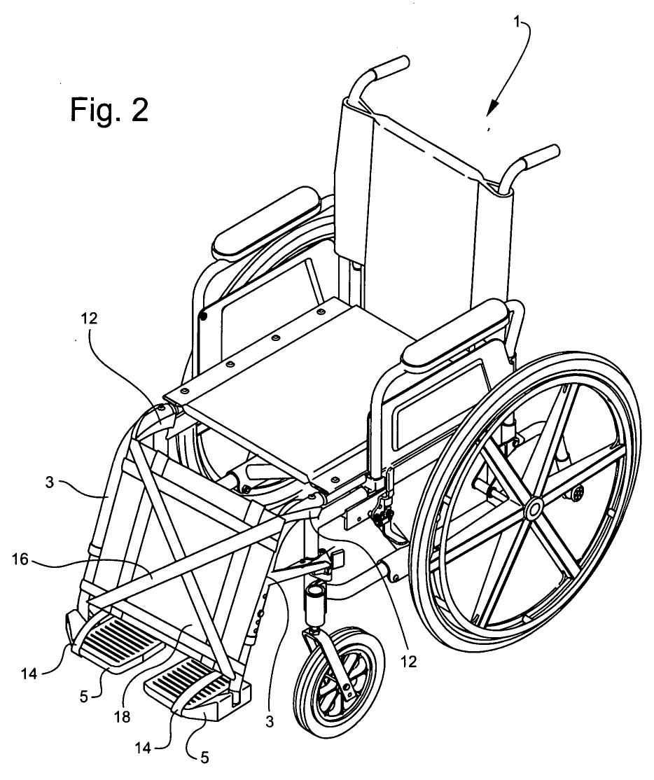

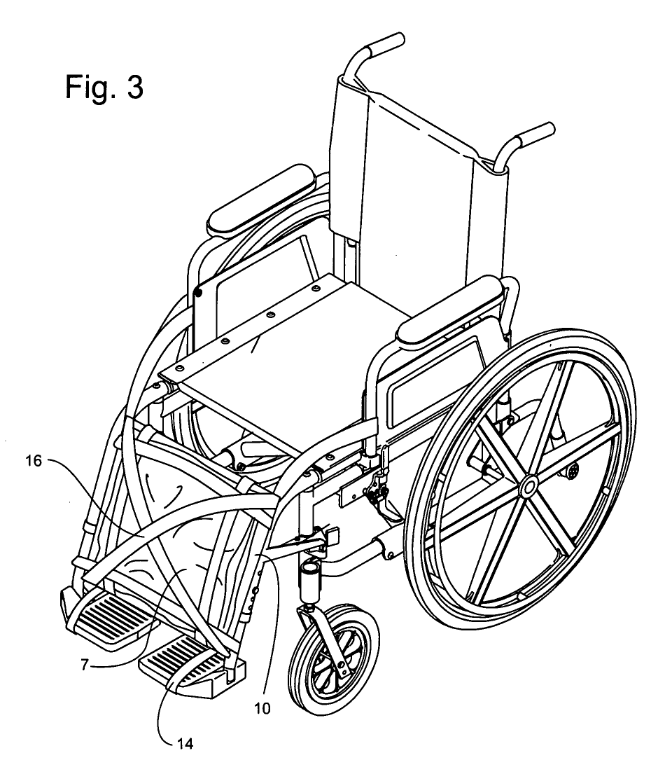

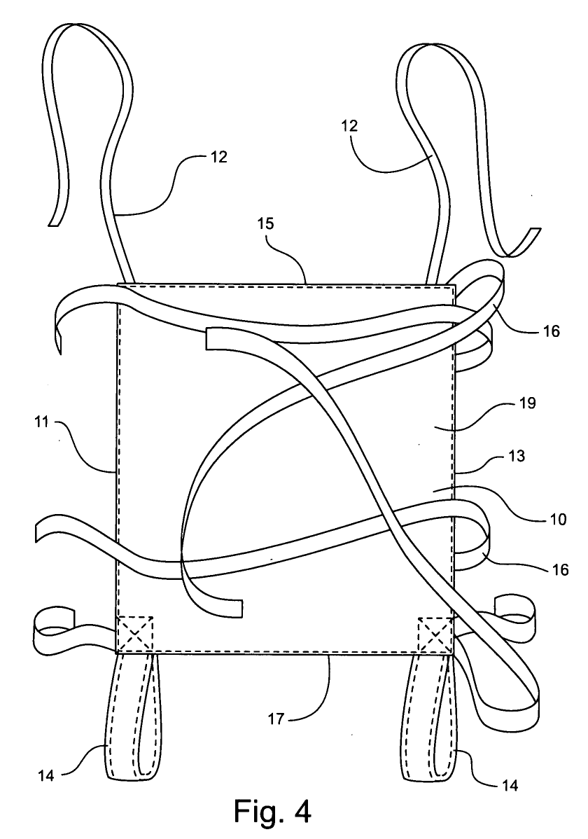

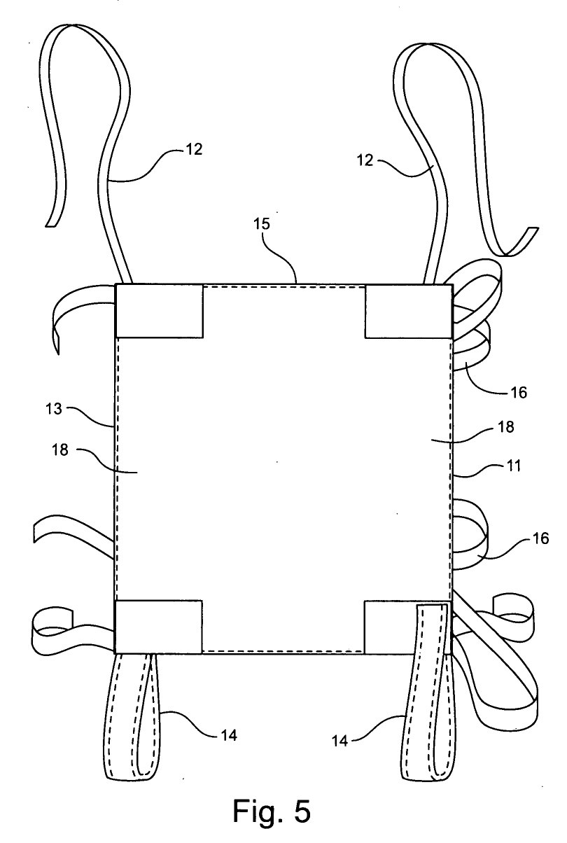

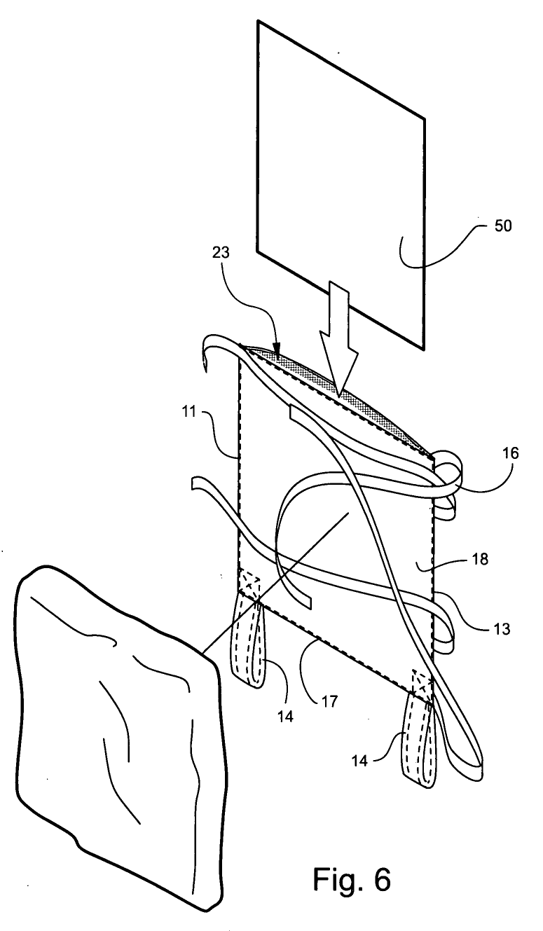

The present invention is a device comprising a pouch 10 as shown in FIG. 4, a solid and flexible sheet 50 that is sized to fit within the pouch 10 as shown in FIG. 6, at least one, preferably two adjustable mounting straps 12 attached to first and second side edges, 11 and 13 respectively, adjacent a top edge 15 for securing the pouch 10 to a wheelchair's first and second leg cradles 3 as shown in FIG. 4, at least one, preferably two footrest straps 14 of fixed length that are attached to a bottom edge 17 of the pouch 10 that further secure the present invention to a wheelchair by wrapping around two metal footrests 5 as shown in FIG. 2, and at least one, preferably three or six holding straps 16 that are secured to the pouch 10 at various positions that will be described below that form a secure holding formation for a leg cushion 7 as shown in FIG. 3.

Preferably, the pouch 10 is rectangular and is made of cloth, vinyl or other flexible and cleanable material. Because of the proximity of the pouch 10 to the floor and skin surface of a passenger, the pouch material must be capable of being sanitized by washing or wiping the surface with a disinfecting solution. The pouch may be of sufficient width to cover the entire area between the outer braces of the first and second leg cradles of the wheelchair as shown in FIG. 2. Alternatively, the pouch 10 may be of a lesser width, covering only a portion of the area between the outer braces of the first and second leg cradles. The pouch 10 is of sufficient height to cover the area from just above the wheelchair's metal footrests and the top end of the first and second leg cradles. Alternatively, the pouch 10 may be of a lesser height, covering only a portion of the area between the wheelchair's metal footrests and the top end of the first and second leg cradles.

The pouch 10 preferably includes two sides of equal dimensions that are joined together on three edges 11, 13, and 17, as shown in FIG. 6. The three edges 11, 13, and 16 are joined together by stitching, melding or gluing the front and back side edges, thus creating a pocket in the pouch with a single opening 23 located on the top edge 15 as shown in FIG. 6. Preferably, the pouch 10 includes hook and loop fasteners along the top edge 15 of the pouch 10 to create a temporary closure between the front and back top edges 15 of the pouch 10. Alternatively, the pouch 10 may include a flap 25 that is attached to the top edge 15 of equal width to the top edge 15 of the pouch 10 as shown in FIG. 6. The alternate flap 25 is sewn or hinged to the back top edge 15, and is of sufficient height to drape the open top edge 15 of the pouch 10.

The solid and flexible sheet 50 is sized to approximate the inside dimensions of the pouch 10, yet is capable of being easily inserted into the pouch 10 through the top edge 15 opening as shown in FIG. 6. Preferably, the sheet 50 is rectangularly shaped and is made of a plastic or waterproof composite rigid or quasi-rigid material. The purpose of the sheet 50 is to provide stability for the pouch 10 as it rests on the outer edges of the left and right leg cradles 3 of the wheelchair 1 and support for the leg cushion 7. The sheet 50 is preferably a material capable of being removed from the pouch 10, cleaned and sanitized.

The pouch 10 is secured to the wheelchair 1 with the at least one, preferably two adjustable mounting straps 12 and at least one, preferably two footrest straps 14 as shown in FIG. 2 and FIG. 4. The two adjustable mounting straps 12 are attached to the lower first and second side edges, 11 and 13 respectively, of the pouch 10 by sewing, melding or gluing as shown in FIG. 4. The adjustable mounting straps 12 are of sufficient length to extend around the outer post of the wheelchair's 1 leg cradles 3, and to join with the back side of the pouch 10 with hook and loop fasteners, or alternative form of fastener such as snaps or clips. The adjustable mounting straps 12 are made of a sturdy cloth or leather material, or alternately a flexible plastic material.

The at least one, preferably two footrest straps 14 are attached to the lower edge 17 of the pouch and extend from the two lower corners of the pouch 10 as shown in FIG. 2 and FIG. 4. The footrest straps 14 are preferably loops and have a fixed length and are secured to the pouch 10 by sewing, melding, or gluing. The footrest straps 14 are positioned to wrap around the wheelchair's 1 footrests and secure the lower edge 17 of the pouch 10 in conjunction with the adjustable mounting straps 12.

The present invention includes at least one, preferable three, or as many as six holding straps 16 that are arranged to support variable-sized cushions 7 when placed on the top surface 28 of the pouch 10 as shown in FIG. 3. The preferred embodiment of the holding straps 16 includes three straps 16 that can each be attached at any two points along the periphery of the pouch 10. The three holding straps 16 include hook and loop fasteners on both ends, and are of sufficient length to attach at any first point along a periphery edge of the pouch 10, extend over the top surface 28 of the leg cushion 7, and reattach to the pouch 10 at a second point along a periphery edge that is opposite the originating first point. The holding straps 16 are of sufficient width to provide a secure pressure hold without compromising the comfort of a leg cushion 7.

A second embodiment of the holding straps 16 includes six holding straps 16 that are fixed at a first end to the pouch 10 by sewing, melding or gluing. A second end of the six holding straps 16 includes a removable fastener. Two holding straps 16 are attached to the top edge 15 of the pouch 10 near the first and second top edge 15 corners as shown in FIG. 4. The holding straps 16 are of equal and sufficient length to extend from the top edge 15 to the bottom edge 17 of the pouch while traversing a variable-sized leg cushion 7. The two holding straps 16 extending from the top edge 15 are secured to the bottom edge 17 of the pouch 10 with hook and loop fasteners, or alternately with snaps, buttons or clips. The holding straps 16 are of sufficient width to provide a secure pressure hold without compromising the comfort of a leg cushion 7.

The second embodiment further includes two holding straps 16 that are attached to the first side edge 11 of the pouch 10 as shown in FIG. 4. The two holding straps 16 are of sufficient length to extend from the first to the second side edge, 11 and 13 respectively, of the pouch 10 while traversing the top side of a leg cushion 7. The holding straps 16 are of sufficient width to provide a secure pressure hold without compromising the comfort of the leg cushion 7. The holding straps 16 are secured to the second side edge 13 of the pouch 10 with hook and loop fasteners, or alternately with snaps or clips.

The second embodiment still further includes two final holding straps 16 that are secured to the upper first side 11 and lower first side 11 corners of the pouch 10 as shown in FIG. 2 and FIG. 4. The holding straps 16 are of sufficient length to extend from the upper first side 11 corner to the lower second side 13 corner of the pouch 10, and from the lower first side 11 corner to the upper second side 13 corner of the pouch 10. The corner holding straps 16 are of sufficient width to provide a secure pressure hold without compromising the comfort of the leg cushion 7. The corner holding straps 16 are secured to the second side 13 upper and lower corners with hook and loop fasteners, or alternately with snaps or clips.

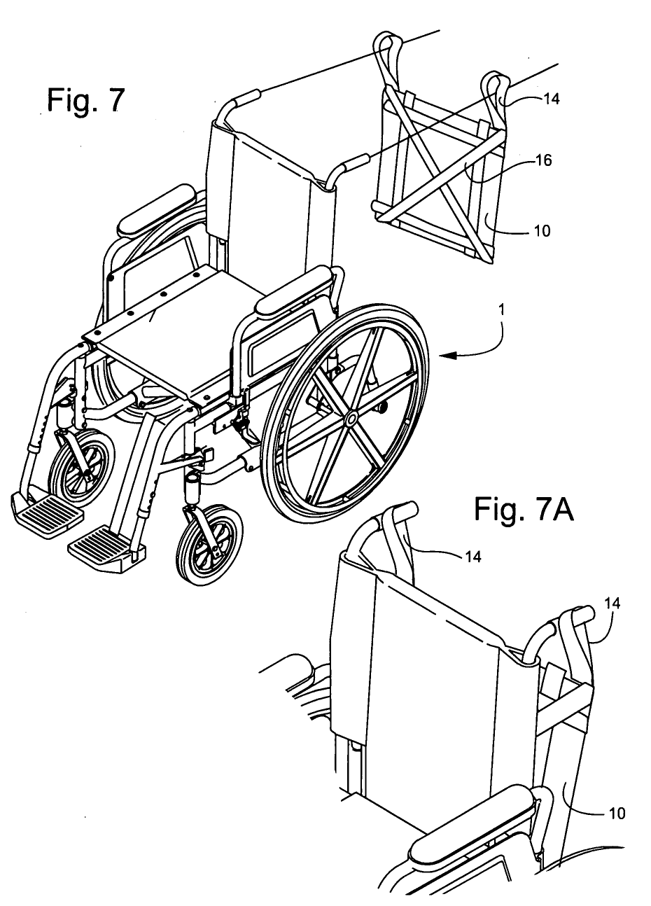

The present invention is easily secured to both a wheelchair 1 and a leg cushion 7 with the straps and loops referenced above. When a passenger elects not to use the present invention while operating their wheelchair 1, the apparatus can be hung from the wheelchair's 1 steering handles by the two footrest straps 14 for ease of stowage and access as shown in FIG. 7 and FIG. 7a.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. An apparatus for providing comfort to wheelchair passengers, comprising:
a, two-sided pouch that is sized at most to approximately cover the area defined by the width between the outer edges of a wheelchair's leg cradles and having a height no greater than equal to the distance between the top of said wheelchair's footrests and the top of said wheelchair's leg cradles;
a solid, flexible sheet that is sized to fit inside of said pouch with sufficient rigidity to provide support for said pouch with a cushion attached thereto;
two adjustable mounting straps attached at first end to said pouch wherein said mounting straps include hook and loop fasteners at second end for securing lower first and second side edges of said pouch to said leg cradles,;
two footrest straps secured to said pouch at lower edge with said footrest straps positioned at lower first and second corners of said pouch; and
at least one and preferably three holding straps with hook and loop fasteners secured to first and second ends of said straps wherein said straps are of sufficient length to removably connect to opposite edges of said pouch while applying a pressure hold across top side of said cushion.

2. The apparatus of claim 1 wherein said pouch, said mounting straps, said footrest straps, and said holding straps are made of a sturdy cloth or leather material; and
said sheet that is made of thin and quasi-rigid plastic material.
